(19) United States
(12) Patent Application Publication
(10) Pub. No.: US 2026/0148078 A1
(43) Pub. Date: May 28, 2026

(54) Calibrating a Machine-Learning Model in a Data Processing Environment

(71) Applicant: THE BOSTON CONSULTING GROUP, INC., Boston, MA (US)

(72) Inventors: Davide Guatta, Boston, MA (US); Oliviero Balbinetti, Boston, MA (US); Francesco Corda, Boston, MA (US)

(21) Appl. No.: 18/963,058

(22) Filed: Nov. 27, 2024

(51) Int. Cl. G06N 3/09; G06Q 30/0202

(52) U.S. Cl. CPC G06N 3/09; G06Q 30/0202

(57) ABSTRACT

A method implemented by a data processing system for calibrating a machine learning model, includes training a machine learning (ML) model, wherein the ML model comprises a plurality of nodes that are connected through edges and are aggregated into a plurality of layers comprising at least an input layer and an output layer, wherein each of the edges is configured to transmit a signal from one node to another node, and wherein an output of each of the plurality of nodes is computed based on inputs of the nodes in accordance with a plurality of weights; generating one or more A/B tests that are related to the area to be improved, determining one or more outcomes from executing the one or more A/B tests; and calibrating the ML model in accordance with the determined one or more outcomes.

### TECHNICAL FIELD

This invention relates to software development for system calibration.

### SUMMARY

In general, a method implemented by a data processing system for calibrating a machine learning model, includes: reading, from one or more hardware storage devices, first input data structures structured with first fields specifying first values, wherein a first data structure includes a key field with a key value specifying a channel; executing, by the data processing system, first executable logic on the first values of the first fields of the first input data structures; based on the executing, outputting first output data structures specifying a plurality of channels specified by key values of the key fields and one or more values for each of the channels; reading, from one or more hardware storage devices, second input data structures structured with second fields specifying second values, wherein a second data structure includes a first key field specifying a value of a Hypertext Transfer Protocol (HTTP) cookie and a second key field specifying a value representing a digital campaign; executing, by the data processing system, second executable logic on the second values of the second fields of the second input data structures and on the values of the first and second key fields; based on the executing, outputting second output data structures specifying attribution data for a plurality of digital channels; training a machine learning (ML) model to predict sales and/or return on investment by digital campaign, wherein the ML model is configured to receive as input the first and second data structures and to process the input to generate an output that specifies a predicted sale and/or a predicted return on investment, wherein the ML model comprises a plurality of nodes that are connected through edges and are aggregated into a plurality of layers comprising at least an input layer and an output layer, wherein each of the edges is configured to transmit a signal from one node to another node, and wherein an output of each of the plurality of nodes is computed based on inputs of the nodes in accordance with a plurality of weights; identifying an area of the machine learning model to be improved; generating one or more A/B tests that are related to the area to be improved, wherein an A/B test is configured to obtain further information that can be used to calibrate or refine the machine learning model in the area to be improved; determining one or more outcomes from executing the one or more A/B tests; and calibrating the ML model in accordance with the determined one or more outcomes.

Implementations of this aspect can include one or more of the following features. The operations include outputting, based on the execution of the second executable logic, a representation of a state of the system specifying digital campaigns for a plurality of customers that have not yet resulted in a conversion. The operations further include inputting, into the ML model, the representation of the state of the system; and generating, by the ML model, a prediction of one or more changes to the state of the system based on the one or more testing parameters.

In some implementations, the first executable logic is a marketing mix model. The second executable logic is a multi-touch attribution model. Training the ML model includes: training a neural network to predict transaction data for a digital campaign using a supervised learning technique based on the training data, wherein the neural network is configured to receive as input at least sales attribution data and to process the input to generate an output that specifies one or more predicted sales, wherein the neural network comprises a plurality of artificial neurons that are connected through edges and are aggregated into a plurality of neural network layers comprising at least an input layer and an output layer, wherein each of the edges is configured to transmit a signal from one artificial neuron to another artificial neuron, and wherein an output of each of the plurality of artificial neurons is computed by a specified function of a sum of inputs of the artificial neuron in accordance with a plurality of weights; and setting values of the plurality of weights based on the training of the neural network; receiving new data indicating sales attributed to a particular digital campaign; and processing, by the data processing system, the new data using the plurality of artificial neurons in the trained neural network in accordance with the values of the plurality of weights to identify predicted transaction data for the digital campaign, wherein the artificial neurons in the input layer are configured to receive the new data as input and the artificial neurons in the output layer are configured to generate a new output that identifies the predicted transaction data. In some implementations, the calibrating includes: outputting functional data that that controls an operation of the ML model.

Other embodiments of this aspect include corresponding computer systems, apparatus, and computer programs recorded on one or more computer storage devices. A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by a data processing apparatus, cause the apparatus to perform the actions.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1 and 2 each illustrates an example data processing environment.

FIG. 3 illustrates an example of training a machine-learning system.

FIG. 4 illustrates an example process for calibrating a machine-learning model.

FIG. 5 is a diagram of an example computing system.

Like reference numbers and designations in the various drawings indicate like elements.

### DETAILED DESCRIPTION

In the realm of digital marketing, it is pivotal for marketers to discern and isolate the contribution each channel and campaign makes to the sales process. This understanding allows for the design of effective marketing strategies and optimal budget allocation. Evaluating this contribution is particularly complex in today's highly connected world, where each campaign is presented to many potential customers. For example, each potential customer browsing the Internet and/or using social media is different. Each potential customer is continuously engaged across many different channels. For example, in a single day, it might be presented with a banner in an email, an ad on Facebook, a sponsored video on YouTube, and a campaign on Google Search. Each potential customer uses different devices (e.g., mobiles, laptops, tablets, etc.), making identification and tracking very difficult. Each potential customer may interact with each campaign/channel in different ways: close the banner, skip the video, view for at least 5 seconds, click, etc. Each potential customer may contribute to one or more sales after an undefined period, engaging with different campaigns and channels during multiple touchpoints. This temporal dimension makes very difficult to evaluate the underlying causal relationship between budget allocated to a specific campaign and its effectiveness. The system described herein addresses this problem by combining: a “top-down” approach that relies on aggregated sales data, a “bottom-up” approach defining “customer journeys” as the series of customer-campaign-channel interactions/touchpoints, an A/B test “experimentation” approach based on incrementality testing, the definition of “state of the system” as the ensemble of all open customer journeys to date, i.e. the series of touchpoints not yet converted into a sale per each potential customer and the definition of “evolution of the system” as the next state the system will transition to under a particular marketing strategy and budget allocation.

The solution grants a more accurate evaluation of the contribution of each channel and campaign to the sales process, equipping marketers with better insights to optimise strategies and allocate budget. Furthermore, it ensures flexibility and provides continuous monitoring through time, whereas “traditional” models require a lot of time and data to be trained and updated. That is, traditional methods require lots of data and time to be trained and updated. For example, marketing mix models (MMMs) require years of aggregated marketing expenditure data to be trained and generate predictions for the upcoming months. This means this approach is not flexible and reactive, requiring months of new observations to be collected for the model to be re-trained and generate a quantitatively different output/marketing allocation. Therefore, it is not possible to “continuously monitor through time” the marketing performance, experiment and adjust promptly.

Conversely, this new approach is flexible and removes these limitations. While it still requires lots of data and time to be trained, it does not suffer at prediction/update stage. Indeed, once the model learned how to represent the state of the system and the underlying relationships between marketing campaigns and paths to conversion, it enables continuous assessment and experimentation with new marketing strategies and budget allocations. As the state of the system evolves, the approach quantifies the impact of various marketing allocations at each point in time by generalising the cause-effect relationship learned for each campaign. That is, the state of the system enables the environment described herein to model a campaign or various marketing strategies before a conversion has ultimately occurred, thereby providing a more flexible approach. In contrast, a MMM is focused on determining a correlation between an input and an outcome. However, the state of the system provides for a more flexible approach by allowing for modeling of various paths to conversion.

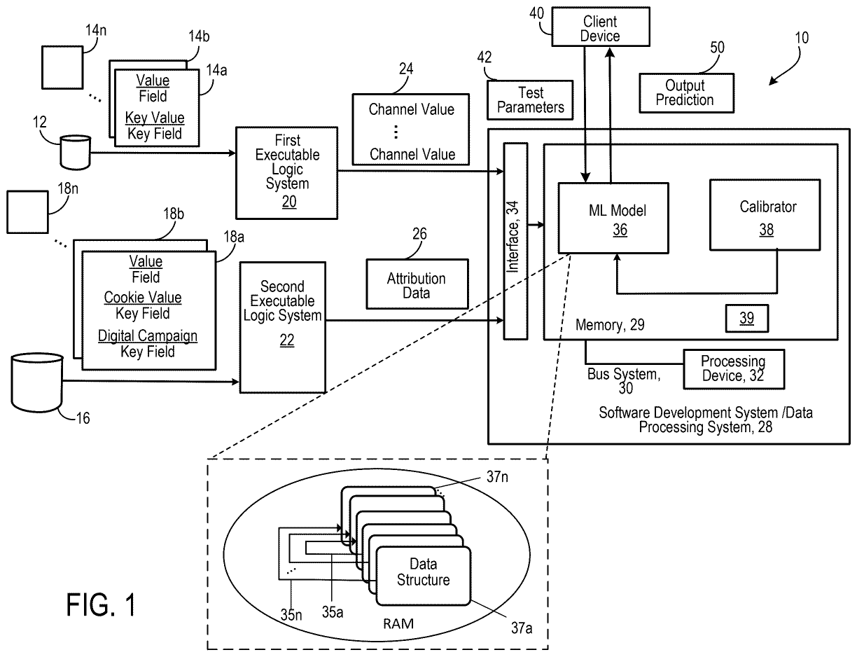

Referring to FIG. 1, data processing environment 10 includes databases 12, 16, first executable logic system 20 and second executable logic system 22. Database 12 transmits first input data structures 14a, 14b . . . 14n. In this example, first input data structure 14a is data structured with fields, including fields that have various values and a key field for storing a key value. In this example, the key field includes values specifying various communication, marketing and/or digital channels, such as television, social media channels and email channels. First input data structures 14a, 14b . . . 14n include key fields specifying key values of various channels to enable attribution tracking of sales to the various channels. In an example, first input data structure 14a includes a key field with a key value of “TV” to specify that the data in that data structure 14a pertains to a TV communication channel, e.g., digital information that is presented on the TV. The value of the other field in first input data structure 14a specifies a value of $25,000 to specify weekly sales data attributed to the digital information presented on the TV. First input data structures 14a, 14b . . . 14n each include a key field to allow data of a specified “type” to be joined or aggregated together. For example, if first input data structure 14b also includes data for a TV communication channel (and a value of $12 k for the other field), then by having a key field with a value of “TV” in first input data structures 14a,14b, first executable logic system 20 aggregates the values of the other fields (i.e., $25 k+$15 k) to identify total sales that are attributable to TV.

First executable logic system 20 is configured to receive first input data structures 14a, 14b . . . 14n and to execute specified logic (e.g., rules) against the input data structures to produce output data structure 24. Output data structure 24 specifies for various channels, various associated values, such as return on investment by channel and attributed sales to all channels. First executable logic system 20 includes an attribution system that is configured with logic to take conversion data for various channels and to attribute a conversion or a part of a conversion to the various channels. Generally, attribution or the act of attributing refers to assigning credit to a channel for conversion. Generally, a conversion refers to a user actually making a purchase (or performing some desired action) in response to or based on view or receipt of various information, such as marketing information.

Second executable logic system 22 receives from database 16 second input data structures 18a, 18b . . . 18n. In this example, second input data structure 18a includes various fields, including a key field for specifying a value of a unique user id (UID) or a cookie that uniquely identifies a user of a system (e.g., a client device) and another key field that uniquely identifies a digital marketing campaign. Generally, a cookie includes a small file or part of a file stored on a World Wide Web user's computer, created and subsequently read by a website server, and containing personal information (such as a user identification code, customized preferences, or a record of pages visited). By the second input data structure 18a including these two distinct key fields, second executable logic system 22 executes logic that determines attribution data 26 for each digital campaign and for each user that is being contacted through the digital campaign. By second input data structures 18a, 18b . . . 18n including fields for specifying values of UIDs or cookies, second executable logic system 22 tracks a state of a digital campaign for each user. In this context, a state refers to where in a digital campaign or journey a user has progressed to. For example, each time a user progresses to a new state of a campaign, database 16 receives (e.g., from one or more external systems) information specifying the UID of the user and the particular state of the campaign that the user has entered. In turn, database 16 transmits this information to second executable logic system 22, thereby allowing second executable logic system 22 to track—for a given UID—a state of a user in a particular campaign. That is, the key fields in second input data structures 18a, 18b . . . 18n enable the system to track, for each individual user, that particular user's progress through a digital campaign. The aggregation of all these progresses is included in the state of the system. This tracking of the individual progress allows the ML model 36 to predict a change in the state of the system in response to one or more test parameters 42.

Second executable logic system 22 outputs attribution data 26. In an example, attribution data 26 specifies for each digital campaign a return on investment (ROI) for that digital campaign. However, second executable logic system 22 can also produce other types of output data, including for example, states of campaigns for a plurality of users, which aspects of a campaign a particular user has viewed or accessed or participated in, where in a particular campaign for a particular user a conversion was made, and so forth. That is, attribution data 26 is relatively low level data that provides details about sales attributed to digital marketing campaigns, whereas output data structure 24 provides more top level information about ROI's for various channels.

Environment 10 also includes software development system 28 (also referred to herein as data processing system 28) with interface 34 for receiving output data structure 24 and attribution data 26. Software development system 28 includes a system for developing software (e.g., a calibrator) to calibrate a machine learning model. In this example, data processing system 28 includes memory 29, which in turn includes a machine learning model 36 and a calibrator 38. In this example, machine learning model 36 receives output data structure 24 and attribution data 26 (via interface 34, which is configured to transmit this information) as input data and is trained on this input data to make one or more predictions about predicted sales and/or return on investment by a particular digital campaign, as described below. In particular, machine learning model 36 receives output data structure to enable machine learning model 36 to be trained on the role traditional channels (e.g., paper mailing, TV, and so forth) may have on ultimately impacting and/or driving a conversion in a digital campaign. That is, even if a conversion is not directly trackable to a TV advertisement, that TV advertisement may have played a role in the ultimate conversion, e.g., by making a user aware of a brand and/or a product such that the user is more receptive to interacting with a digital ad for that product or brand in the future. As such, machine learning model 36 is able to account for these effects or influences of traditional channels, even when making a prediction regarding sales of a digital marketing campaign. Because machine learning model 36 is able to account for these traditional channels too, machine learning model 36 is able to make more accurate predictions and more comprehensive predictions, e.g., by assessing all underlying data. Machine learning model 36 uses reinforcement learning as part of the training, as further described below.

Memory 29 also includes calibrator 38 that produces outputs for calibrating and/or improving an accuracy of machine learning model 36. In some examples, machine learning model 36 identifies areas of the model to be improved. Once such an area has been identified, machine learning model 36 outputs to calibrator 38 information specifying the area to be improved and a proposed technique to improve that area. Calibrator 38 generates A/B tests to test the proposed technique, e.g., using matched markets. In an example, calibrator 38 generates a first test (e.g., test A) to test the proposed technique in a first market and a second test (e.g., test B) to test the proposed technique in a second market that is similar to the first market. Calibrator 38 executes the two tests and sends to machine learning model via a feedback loop information on results of the testing to calibrate machine learning model 36. The tests are essentially selecting two different sets of users, and then executing a different marketing strategy (e.g., different marketing spend, different channel distribution, etc.) for the two markets. Some of this might need to be performed manually by the human (e.g., coordinating marketing strategies in traditional channels), though perhaps some of it can be fully automated (e.g., for digital channels).

In some implementations, machine learning model 36 automatically identifies areas of the model to be improved. For instance, machine learning model 36 can determine that although the model can attribute a particular change in return to marketing spend across several different channels, it is unable to accurately attribute the marketing spend in each channel individually to the overall change in return. As an example, a company that is increasing marketing for a product may increase marketing spend across multiple channels concurrently (e.g., TV, radio, digital, etc.), and may see an increase in demand for the product as a result of their marketing strategy. However, if machine learning model 36 were trained solely on this data, the model may, at least in some implementations, be unable to accurately distinguish between the contribution of marketing spend for each of these channels individually. Accordingly, machine learning model 36 may inaccurately predict the return of marketing spend in future use cases.

To improve the accuracy of predictions, machine learning model 36 can identify these potential gaps in the model and provide them (as areas for improvement 38a) to the calibrator 38. Based on this information, the calibrator 38 can generate one or more A/B tests to obtain further information that can be used to calibrate or refine the machine learning model 36. For example, if machine learning model 36 determines that it cannot accurately attribute an increase in return in some circumstances, whereby TV and digital marketing were increased by an equal amount concurrently, the calibrator 38 can generate an A/B test in which, under similar circumstances, TV marketing is increased for a first subset of users (and digital marketing kept the same), and digital marketing is increased for a second subset of users (and TV marketing kept the same). The results of this test (e.g., the corresponding change in return in response to the different marketing spends) can be used as additional training data to train the machine learning model 36, such that the model can better differentiate the effects of each channel (and corresponding marketing spend) on the overall return.

In an example, calibrator 38 outputs functional data 39 to machine learning model 36 to control an operation of machine learning model 36. In an example, the functional data includes an electronic message with a header and a content section. Information in the header comprises instructions which are automatically recognized and processed by the receiving message system, which - in this example - is machine learning model 36. This processing in turn determines how the content elements (e.g., data in the contents section including the calibration data (i.e., data to be used for calibration, data representative of outcomes of the A/B testing, and so forth)) are to be assembled to be processed and analyzed by machine learning model 36, which - for example - may be executing on or otherwise embedded in a machine learning system. For example, the header specifies that the incoming data is calibration data and - in some examples - may specify which nodes of the machine learning model 36 are affected by the calibration data. Machine learning model 36 processes the header to identify the affected nodes, look up memory locations representing those nodes and access data stored in those memory locations to update and/or modify and/or re-train the logic of the machine learning model pertaining to those nodes in accordance with the content elements. In other examples, machine learning model 36 is re-trained using the calibration data, which specifies which outcomes are desired and which outcomes are undesired.

In an example, machine learning model 36 includes data structures 37a . . . 37n stored in memory (e.g., random access memory) to increase a speed of accessing the data structures. Each of data structures 37a . . . 37n represents nodes in a machine learning model. Each of data structures 37a . . . 37n are traversed by one or more pointers 35a . . . 35n, e.g., pointers specifying a location in memory where one or more of data structures 37a . . . 37n are stored. The header in functional data 39 can include the memory locations of one or more of data structures 37a . . . 37n to specify which nodes need to be targeted and accessed in the training based on the calibration data, e.g., to increase a speed of training machine learning model 36.

Once machine learning model 36 is trained, client device 40 transmits to machine learning model 36 various test parameters 42 including, for example, parameters specifying a change to a marketing budget. In response, machine learning model 36 outputs prediction data 50 specifying what would be the predicted outcome for a particular budget and/or what would be a return on investment for a particular budget for a particular campaign. Generally, prediction data 50 includes predicted transaction data, including, e.g., data specifying one or more predictions related to one or more transactions. Predicted transaction data includes data specifying predicted sales during a short and/or long-time horizon, return on investment by marketing campaign, and so forth.

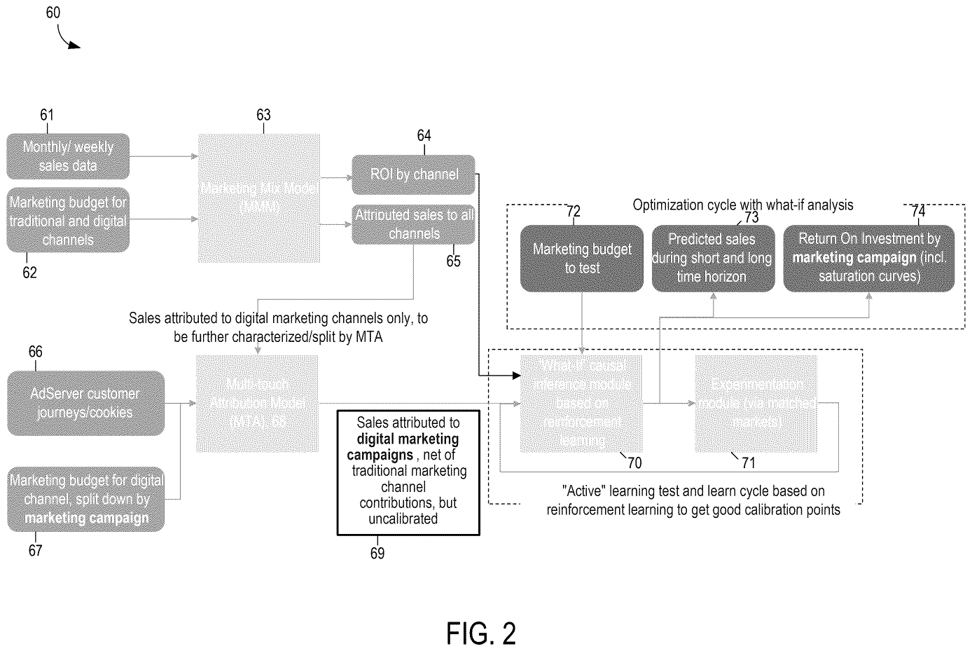

Referring to FIG. 2, data processing environment 60 is shown. In this example, MMM 63 receives various forms of input data, including monthly/weekly sales data 61 (input data 61) and marketing budget data 62 (input data 62) for traditional and digital channels. Using input data 61, 62, MMM model 63 outputs data 64 representing ROI by channel and data 65 representing attributed sales to all channels. Data 64 is input into machine learning system 70. Data 65 is transmitted to multi-touch attribution (MTA) model 68, which parses through the received data to identify data representing sales attributed to digital marketing channels only. MTA model 68 also receives from one or more external data sources and/or client devices input data 66 about customer journeys and associated HTTP cookies that uniquely identify a user associated with the journey. MTA model 68 also receives input data 67 specifying marketing budget for digital channel, which is split down by marketing campaign. Using input data 66, 67 MTA model 68 produces attribution data 69 specifying sales attributed to digital marketing campaigns. In producing attribution data 69, MTA model 68 also identifies a state of the system. Generally, a state of the system refers to open customer journeys to date. An open customer journey is a customer journey or campaign that has not yet resulted in a conversion. So, the state of the system refers to all the customer journeys that had not yet resulted in a conversion and in particular, where each customer is in that customer journey. The state of the system also includes - for users specified with a UID - where in a journey or campaign the user is. As described in further detail below, the machine learning model 70 uses this state of the system information to predict, e.g., based on one or more input parameters specifying one or more changes, a change in the statue of the system.

That is, this state of the system information can be transmitted to the machine learning model 70 as input to enable the machine learning model 70 to predict based on one or more changes, such as changes to a budget, what would be the change to the state of the system. MTA model 68 transmits attribution data 69 to machine learning model 70. Machine learning model 70 receives test parameter 72 specifying a particular marketing budget that a user wants to test. In response to receiving test parameter 72, machine learning model 70 generates prediction data 73 and 74. In this example, prediction data 73 specifies predicted sales during both a short and long time horizon. Prediction data 74 specifies the return on investment by marketing campaign. Machine learning model 70 also transmits prediction data 73, 74 to experimentation module 71. Experimentation module 71 performs one or more experiments on prediction data 73, 74 to determine an accuracy of prediction data 73, 74. This indication of accuracy is then fed from experimentation module 71 back to machine learning module 70 to calibrate machine learning module 70, for example, by specifying to machine learning module 70 that the particular prediction was very accurate or that the particular prediction was not accurate, and what the actual result of the experiment was to allow machine learning model 70 to train or re-train on that higher quality data.

Generally, machine-learning can encompass a wide variety of different techniques that are used to train a machine to perform specific tasks without being specifically programmed to perform those tasks. The machine can be trained using different machine-learning techniques, including, for example, supervised learning, unsupervised learning, and reinforcement learning. In supervised learning, inputs and corresponding outputs of interest are provided to the machine. The machine adjusts its functions in order to provide the desired output when the inputs are provided. Supervised learning is generally used to teach a computer to solve problems in which are outcome determinative, for example, the training set may be used to train the trained machine-learning model to predict an expected frequency and amount of an unexpected expense over a period of time. In contrast, in unsupervised learning, inputs are provided without providing a corresponding desired output. Unsupervised learning is generally used in classification problems such as, customer segmentation (for example, segmenting patients into different groups based on characteristics associated with hypoglycemic events). Reinforcement learning describes an algorithm in which a machine makes decisions using trial and error. Feedback informs the machine when a good choice or bad choice is made. The machine then adjusts its algorithms accordingly. For example, the trained learning model may be embodied as a generalized linear model (GLM). Different types of generalized linear models may be appropriate in various scenarios. A zero-inflated negative binomial generalized linear regression may be used because it models a discrete count of events (such as conversions) occurring in a given time period, by estimating the per-patient hypoglycemic event rates most likely to have resulted in the hypoglycemic counts seen in the data. In some implementations, the model may use a Poisson GLM. A Poisson GLM is well suited to modeling discrete counts but does not allow for ‘over-dispersion’ (i.e. it constrains the variance to be equal to the mean). The Poisson GLM used the number of hypoglycemic events as the target variable (outcome) and the length of observation as an offset variable.

In another example, the trained learning model may be embodied as an artificial neural network. Artificial neural networks (ANNs) or connectionist systems are computing systems inspired by the biological neural networks that constitute animal brains. An ANN is based on a collection of connected units or nodes, called artificial neurons. Each connection, like the synapses in a biological brain, can transmit a signal from one artificial neuron to another. An artificial neuron that receives a signal can process it and then signal additional artificial neurons connected to it.

In common ANN implementations, the signal at a connection between artificial neurons is a real number, and the output of each artificial neuron is computed by some non-linear function of the sum of its inputs. The connections between artificial neurons are called ‘edges’. Artificial neurons and edges may have a weight that adjusts as learning proceeds (for example, each input to an artificial neuron may be separately weighted). The weight increases or decreases the strength of the signal at a connection. Artificial neurons may have a threshold such that the signal is only sent if the aggregate signal crosses that threshold. The transfer functions along the edges usually have a sigmoid shape, but they may also take the form of other non-linear functions, piecewise linear functions, or step functions. Typically, artificial neurons are aggregated into layers. Different layers may perform different kinds of transformations on their inputs. Signals travel from the first layer (the input layer), to the last layer (the output layer), possibly after traversing the layers multiple times.

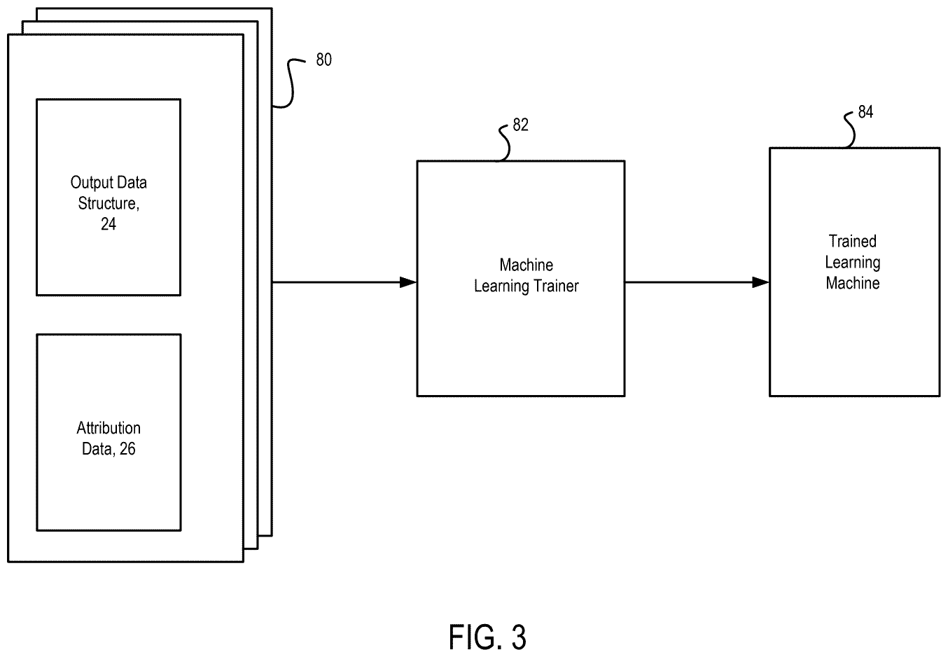

FIG. 3 illustrates an example of training a machine-learning system. For example, training sets 80 may be created using attribution data (e.g., attribution data 26) of individuals in different digital campaigns. The training sets may include the output data set 24 and details of attribution (as specified in attribution data 24) that occurred for various campaigns and various users during the period of time for which training data is available. Using machine-learning techniques as described above, a model may be trained, by the machine-learning trainer 82, to determine the predicted sales and/or return on investment. In some implementations, a single trained learning machine 84 may be trained. In other implementations, multiple models may be trained based on attributed sales to all channels and sales attributed to digital marketing campaigns (e.g., as specified by output data structure 24 and attribution data 26, respectively).

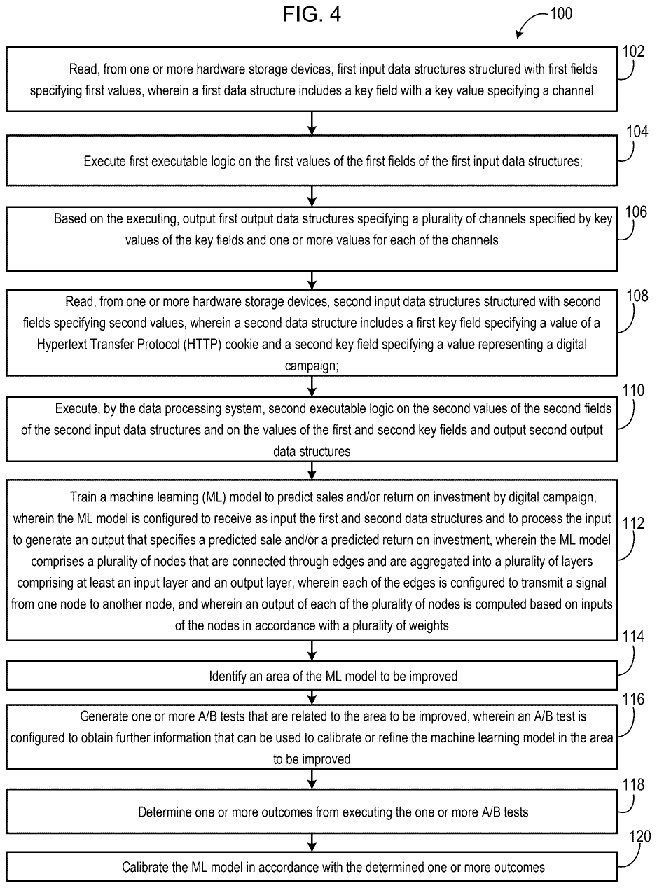

Referring to FIG. 4, a process 100 is shown for calibrating a machine-learning model. Operations of the process 100 include reading (102), from one or more hardware storage devices, first input data structures structured with first fields specifying first values, wherein a first data structure includes a key field with a key value specifying a channel. The operations also include executing (104), by the data processing system, first executable logic on the first values of the first fields of the first input data structures. The operations also include based on the executing, outputting (106) first output data structures specifying a plurality of channels specified by key values of the key fields and one or more values for each of the channels. The operations also include reading (108), from one or more hardware storage devices, second input data structures structured with second fields specifying second values, wherein a second data structure includes a first key field specifying a value of a Hypertext Transfer Protocol (HTTP) cookie and a second key field specifying a value representing a digital campaign. The operations also include executing (110), by the data processing system, second executable logic on the second values of the second fields of the second input data structures and on the values of the first and second key fields, and based on the executing, outputting second output data structures specifying attribution data for a plurality of digital channels. The operations include training (112) a machine learning (ML) model to predict sales and/or return on investment by digital campaign, wherein the ML model is configured to receive as input the first and second data structures and to process the input to generate an output that specifies a predicted sale and/or a predicted return on investment, wherein the ML model comprises a plurality of nodes that are connected through edges and are aggregated into a plurality of layers comprising at least an input layer and an output layer, wherein each of the edges is configured to transmit a signal from one node to another node, and wherein an output of each of the plurality of nodes is computed based on inputs of the nodes in accordance with a plurality of weights. The operations include identifying (114) an area of the machine learning model to be improved. The operations include generating (116) one or more A/B tests that are related to the area to be improved, wherein an A/B test is configured to obtain further information that can be used to calibrate or refine the machine learning model in the area to be improved. The operations include determining (116) one or more outcomes from executing the one or more A/B tests. The operations include calibrating (118) the ML model in accordance with the determined one or more outcomes.

### Example Computing Environment

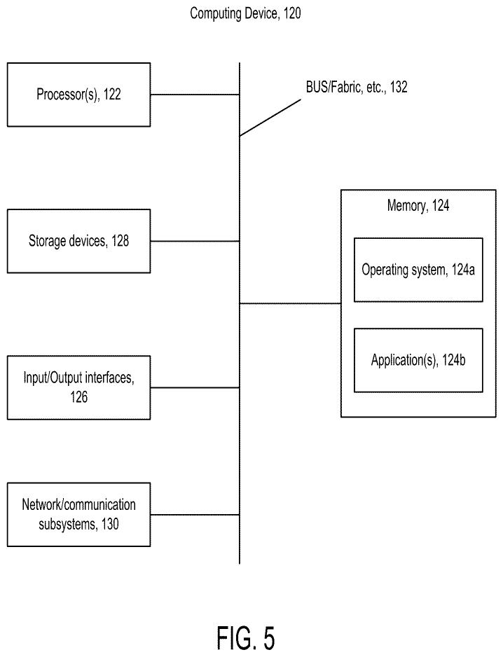

Referring to FIG. 5, an example operating environment for implementing embodiments of the present invention is shown and designated generally as computing device 120. Essential elements of a computing device 120 or a computer or data processing system or client or server are one or more programmable processors 122 for performing actions in accordance with instructions and one or more memory devices 124 for storing instructions and data. Generally, a computer will also include, or be operatively coupled, (via bus 132, fabric, network, etc.) to I/O components 126, e.g., display devices, network/communication subsystems, etc. (not shown) and one or more mass storage devices 128 for storing data and instructions, etc., and a network communication subsystem 130, which are powered by a power supply (not shown). In memory devices 124, are an operating system 124a and applications 124b for application programming.

The computer program instructions and data may be stored in non-transitory form, such as being embodied in a hardware storage device, including, e.g., a volatile storage medium (e.g., random access memory (RAM)) or a non-volatile storage medium (e.g., disk), or any other non-transitory medium, using a physical property of the medium (e.g., magnetic domains, or electrical charge) for a period of time (e.g., the time between refresh periods of a dynamic memory device such as a dynamic RAM). In preparation for loading the instructions, the software may be provided on a tangible, non-transitory medium, such as a CD-ROM or other computer-readable medium (e.g., readable by a general or special purpose computing system or device), or may be delivered (e.g., encoded in a propagated signal) over a communication medium of a network to a tangible, non-transitory medium of a computing system where it is executed. Some or all of the processing may be performed on a special purpose computer, or using special-purpose hardware, such as coprocessors or field-programmable gate arrays (FPGAs) or dedicated, application-specific integrated circuits (ASICs). The processing may be implemented in a distributed manner in which different parts of the computation specified by the software are performed by different computing elements. Each such computer program is stored on or downloaded (from a cloud computing infrastructure or other remote source) to a computer-readable storage medium (e.g., solid state memory or media, or magnetic or optical media) of a storage device accessible by a general or special purpose programmable computer, for configuring and operating the computer when the storage device medium is read by the computer to perform the processing described herein. Each such computer program may also be accessed as a service provided by cloud computing infrastructure. The embodiments described herein may also be implemented as a tangible, non-transitory medium, configured with a computer program, where the medium so configured causes a computer to operate in a specific and predefined manner to perform one or more of the processing steps described herein.

The computer program may include one or more modules of a larger program. The modules of the program can be implemented as data structures or other organized data conforming to a data model stored in a data repository.

To provide for interaction with a user, embodiments of the subject matter described in this specification can be implemented on a computer having a display device (monitor) for displaying information to the user, and a keyboard and a pointing device, (e.g., a mouse or a trackball) by which the user can provide input to the computer. In addition, a computer can interact with a user by sending documents to and receiving documents from a device that is used by the user (for example, by sending web pages to a web browser on a user's device in response to requests received from the web browser).

Embodiments of the subject matter described in this specification can be implemented in a computing system that includes a back end component (e.g., as a data server), or that includes a middleware component (e.g., an application server), or that includes a front end component (e.g., a user computer having a graphical user interface or a Web browser through which a user can interact with an implementation of the subject matter described in this specification), or any combination of one or more such back end, middleware, or front end components. The components of the system can be interconnected by any form or medium of digital data communication (e.g., a communication network). Examples of communication networks include a local area network (“LAN”), a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the user device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments, and it should be understood that the described program components and systems can generally be integrated together in a single software product or packaged into multiple software products.

A number of embodiments have been described. Nevertheless, it will be understood that various modifications may be made without departing from the spirit and scope of the techniques described herein. For example, some of the steps described above may be order independent, and thus can be performed in an order different from that described. Accordingly, other embodiments are within the scope of the following claims.

What is claimed is:

1. A method implemented by a data processing system for calibrating a machine learning model, including:
reading, from one or more hardware storage devices, first input data structures structured with first fields specifying first values, wherein a first data structure includes a key field with a key value specifying a channel;
executing, by the data processing system, first executable logic on the first values of the first fields of the first input data structures;
based on the executing, outputting first output data structures specifying a plurality of channels specified by key values of the key fields and one or more values for each of the channels;
reading, from one or more hardware storage devices, second input data structures structured with second fields specifying second values, wherein a second data structure includes a first key field specifying a value of a Hypertext Transfer Protocol (HTTP) cookie and a second key field specifying a value representing a digital campaign;
executing, by the data processing system, second executable logic on the second values of the second fields of the second input data structures and on the values of the first and second key fields;
based on the executing, outputting second output data structures specifying attribution data for a plurality of digital channels;
training a machine learning (ML) model to predict sales and/or return on investment by digital campaign, wherein the ML model is configured to receive as input the first and second data structures and to process the input to generate an output that specifies a predicted sale and/or a predicted return on investment, wherein the ML model comprises a plurality of nodes that are connected through edges and are aggregated into a plurality of layers comprising at least an input layer and an output layer, wherein each of the edges is configured to transmit a signal from one node to another node, and wherein an output of each of the plurality of nodes is computed based on inputs of the nodes in accordance with a plurality of weights;
identifying an area of the machine learning model to be improved;
generating one or more A/B tests that are related to the area to be improved, wherein an A/B test is configured to obtain further information that can be used to calibrate or refine the machine learning model in the area to be improved;
determining one or more outcomes from executing the one or more A/B tests; and
calibrating the ML model in accordance with the determined one or more outcomes.

2. The method of claim 1, further including:
outputting, based on the execution of the second executable logic, a representation of a state of the system specifying digital campaigns for a plurality of customers that have not yet resulted in a conversion.

3. The method of claim 2, further including:
inputting, into the ML model, the representation of the state of the system; and
generating, by the ML model, a prediction of one or more changes to the state of the system based on the one or more testing parameters.

4. The method of claim 1, wherein the first executable logic is a marketing mix model.

5. The method of claim 1, wherein the second executable logic is a multi-touch attribution model.

6. The method of claim 1, wherein training the ML model includes:
training a neural network to predict transaction data for a digital campaign using a supervised learning technique based on the training data, wherein the neural network is configured to receive as input at least sales attribution data and to process the input to generate an output that specifies one or more predicted sales, wherein the neural network comprises a plurality of artificial neurons that are connected through edges and are aggregated into a plurality of neural network layers comprising at least an input layer and an output layer, wherein each of the edges is configured to transmit a signal from one artificial neuron to another artificial neuron, and wherein an output of each of the plurality of artificial neurons is computed by a specified function of a sum of inputs of the artificial neuron in accordance with a plurality of weights; and
setting values of the plurality of weights based on the training of the neural network;
receiving new data indicating sales attributed to a particular digital campaign; and
processing, by the data processing system, the new data using the plurality of artificial neurons in the trained neural network in accordance with the values of the plurality of weights to identify predicted transaction data for the digital campaign, wherein the artificial neurons in the input layer are configured to receive the new data as input and the artificial neurons in the output layer are configured to generate a new output that identifies the predicted transaction data.

7. The method of claim 1, wherein calibrating includes:
outputting functional data that controls an operation of the ML model.

8. A data processing system for calibrating a machine learning model, including:
one or more processing devices; and
one or more machine-readable hardware storage devices storing instructions that are executable by the one or more processing devices to perform operations including:
reading first input data structures structured with first fields specifying first values, wherein a first data structure includes a key field with a key value specifying a channel;
executing first executable logic on the first values of the first fields of the first input data structures;
based on the executing, outputting first output data structures specifying a plurality of channels specified by key values of the key fields and one or more values for each of the channels;
reading second input data structures structured with second fields specifying second values, wherein a second data structure includes a first key field specifying a value of a Hypertext Transfer Protocol (HTTP) cookie and a second key field specifying a value representing a digital campaign;
executing second executable logic on the second values of the second fields of the second input data structures and on the values of the first and second key fields;
based on the executing, outputting second output data structures specifying attribution data for a plurality of digital channels;
training a machine learning (ML) model to predict sales and/or return on investment by digital campaign, wherein the ML model is configured to receive as input the first and second data structures and to process the input to generate an output that specifies a predicted sale and/or a predicted return on investment, wherein the ML model comprises a plurality of nodes that are connected through edges and are aggregated into a plurality of layers comprising at least an input layer and an output layer, wherein each of the edges is configured to transmit a signal from one node to another node, and wherein an output of each of the plurality of nodes is computed based on inputs of the nodes in accordance with a plurality of weights;
identifying an area of the machine learning model to be improved;
generating one or more A/B tests that are related to the area to be improved, wherein an A/B test is configured to obtain further information that can be used to calibrate or refine the machine learning model in the area to be improved;
determining one or more outcomes from executing the one or more A/B tests; and
calibrating the ML model in accordance with the determined one or more outcomes.

9. The data processing system of claim 8, wherein the operations further include:
outputting, based on the execution of the second executable logic, a representation of a state of the system specifying digital campaigns for a plurality of customers that have not yet resulted in a conversion.

10. The data processing system of claim 9, wherein the operations further include:
inputting, into the ML model, the representation of the state of the system; and
generating, by the ML model, a prediction of one or more changes to the state of the system based on the one or more testing parameters.

11. The data processing system of claim 8, wherein the first executable logic is a marketing mix model.

12. The data processing system of claim 8, wherein the second executable logic is a multi-touch attribution model.

13. The data processing system of claim 8, wherein training the ML model includes:
training a neural network to predict transaction data for a digital campaign using a supervised learning technique based on the training data, wherein the neural network is configured to receive as input at least sales attribution data and to process the input to generate an output that specifies one or more predicted sales, wherein the neural network comprises a plurality of artificial neurons that are connected through edges and are aggregated into a plurality of neural network layers comprising at least an input layer and an output layer, wherein each of the edges is configured to transmit a signal from one artificial neuron to another artificial neuron, and wherein an output of each of the plurality of artificial neurons is computed by a specified function of a sum of inputs of the artificial neuron in accordance with a plurality of weights; and
setting values of the plurality of weights based on the training of the neural network;
receiving new data indicating sales attributed to a particular digital campaign; and
processing, by the data processing system, the new data using the plurality of artificial neurons in the trained neural network in accordance with the values of the plurality of weights to identify predicted transaction data for the digital campaign, wherein the artificial neurons in the input layer are configured to receive the new data as input and the artificial neurons in the output layer are configured to generate a new output that identifies the predicted transaction data.

14. The data processing system of claim 8, wherein calibrating includes:
outputting functional data that controls an operation of the ML model.

15. One or more machine-readable hardware storage devices for calibrating a machine learning model, the one or more machine-readable hardware storage devices storing instructions that are executable by the one or more processing devices to perform operations including:
reading first input data structures structured with first fields specifying first values, wherein a first data structure includes a key field with a key value specifying a channel;
executing first executable logic on the first values of the first fields of the first input data structures;
based on the executing, outputting first output data structures specifying a plurality of channels specified by key values of the key fields and one or more values for each of the channels;
reading second input data structures structured with second fields specifying second values, wherein a second data structure includes a first key field specifying a value of a Hypertext Transfer Protocol (HTTP) cookie and a second key field specifying a value representing a digital campaign;
executing second executable logic on the second values of the second fields of the second input data structures and on the values of the first and second key fields;
based on the executing, outputting second output data structures specifying attribution data for a plurality of digital channels;
training a machine learning (ML) model to predict sales and/or return on investment by digital campaign, wherein the ML model is configured to receive as input the first and second data structures and to process the input to generate an output that specifies a predicted sale and/or a predicted return on investment, wherein the ML model comprises a plurality of nodes that are connected through edges and are aggregated into a plurality of layers comprising at least an input layer and an output layer, wherein each of the edges is configured to transmit a signal from one node to another node, and wherein an output of each of the plurality of nodes is computed based on inputs of the nodes in accordance with a plurality of weights;
identifying an area of the machine learning model to be improved;
generating one or more A/B tests that are related to the area to be improved, wherein an A/B test is configured to obtain further information that can be used to calibrate or refine the machine learning model in the area to be improved;
determining one or more outcomes from executing the one or more A/B tests; and
calibrating the ML model in accordance with the determined one or more outcomes.

16. The one or more machine-readable hardware storage devices of claim 15, wherein the operations further include:
outputting, based on the execution of the second executable logic, a representation of a state of the system specifying digital campaigns for a plurality of customers that have not yet resulted in a conversion.

17. The one or more machine-readable hardware storage devices of claim 16, wherein the operations further include:
inputting, into the ML model, the representation of the state of the system; and
generating, by the ML model, a prediction of one or more changes to the state of the system based on the one or more testing parameters.

18. The one or more machine-readable hardware storage devices of claim 15, wherein the first executable logic is a marketing mix model.

19. The one or more machine-readable hardware storage devices of claim 15, wherein the second executable logic is a multi-touch attribution model.

20. The one or more machine-readable hardware storage devices of claim 15, wherein training the ML model includes:
training a neural network to predict transaction data for a digital campaign using a supervised learning technique based on the training data, wherein the neural network is configured to receive as input at least sales attribution data and to process the input to generate an output that specifies one or more predicted sales, wherein the neural network comprises a plurality of artificial neurons that are connected through edges and are aggregated into a plurality of neural network layers comprising at least an input layer and an output layer, wherein each of the edges is configured to transmit a signal from one artificial neuron to another artificial neuron, and wherein an output of each of the plurality of artificial neurons is computed by a specified function of a sum of inputs of the artificial neuron in accordance with a plurality of weights; and
setting values of the plurality of weights based on the training of the neural network;
receiving new data indicating sales attributed to a particular digital campaign; and
processing, by the data processing system, the new data using the plurality of artificial neurons in the trained neural network in accordance with the values of the plurality of weights to identify predicted transaction data for the digital campaign, wherein the artificial neurons in the input layer are configured to receive the new data as input and the artificial neurons in the output layer are configured to generate a new output that identifies the predicted transaction data.
